(19) United States
(12) Patent Application Publication
(10) Pub. No.: US 2025/0300730 A1
(43) Pub. Date: Sep. 25, 2025

(54) SYSTEMS AND METHODS FOR DETECTING OPTICAL SWITCH ANOMALY IN OPTICAL NODE

(71) Applicant: NIPPON TELEGRAPH AND TELEPHONE CORPORATION, Tokyo (JP)

(72) Inventors: Hiroshi WATANABE, Musashino-shi, Tokyo (JP); Kazuhide NAKAE, Musashino-shi, Tokyo (JP); Ryo KOYAMA, Musashino-shi, Tokyo (JP); Tomohiro KAWANO, Musashino-shi, Tokyo (JP); Saki NOZOE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/861,474

(22) PCT Filed: May 6, 2022
(86) PCT No.: PCT/JP2022/019587

§ 371 Date: Oct. 29, 2024

(51) Int. Cl. H04B 10/077; H04Q 11/00

(52) U.S. Cl. CPC H04B 10/077; H04Q 11/0062; H04Q 2011/0083

(57) ABSTRACT

An object of the present disclosure is to enable detection of an abnormality of an optical switch inside an optical node.

According to the present disclosure, the remote control device is connected to an optical fiber network in which a plurality of optical nodes are connected to each other and performs connection switching of the optical fiber network by remote operation using optical switches provided in the optical nodes, in which, in a specific optical node of the plurality of optical nodes, a plurality of optical switches provided in the specific optical node are connected to each other, a test beam is transmitted to one of the plurality of optical switches, and whether or not an abnormality occurs in one of the plurality of optical switches is determined based on whether or not the test beam has been detected in the plurality of optical switches.

### TECHNICAL FIELD

The present disclosure relates to a technology for detecting an abnormal position of an optical switch in an optical node in an optical fiber network in which the optical nodes are connected to each other.

### BACKGROUND ART

In an optical fiber network in which optical nodes are connected to each other, particularly, in an access network connecting a communication device installed in a communication building to a communication terminal on a user side, connection switching such as connection of an optical fiber to any route and a change in route is performed at a certain frequency in order to efficiently use the facility for establishment and maintenance of the network. Such work is generally performed manually at a site of the work to switch the connection of the optical fiber, but a technology of performing connection switching of an optical fiber by remote operation has been proposed (see, for example, Non Patent Literature 1).

In Non Patent Literature 1, an optical port monitoring function of detecting a part of an optical signal passing through an optical switch is provided. However, in Non Patent Literature 1, it is not possible to detect an abnormality of an optical switch inside an optical node.

### CITATION LIST

### Non Patent Literature

Non Patent Literature 1:2021 Institute of Electronics, Information and Communication Engineers Society Conference, BK-2-3, 2021

### SUMMARY OF INVENTION

### Technical Problem

An object of the present disclosure is to enable detection of an abnormality of an optical switch inside an optical node.

### Solution to Problem

A remote operation system of the present disclosure includes: a remote control device of the present disclosure; and a plurality of optical nodes which are connected in the optical fiber network and in which connection switching of a plurality of optical switches provided in the remote control device is performed using a power supply beam from the remote control device.

The remote control device executes a method for detecting an abnormality of the present disclosure.

The method for detecting an abnormality of the present disclosure is executed by the remote control device of the present disclosure, the method including: connecting a plurality of optical switches provided in a specific optical node to each other, in the specific optical node of the plurality of optical nodes; transmitting a test beam to one of the plurality of optical switches; and determining whether or not an abnormality occurs in the plurality of optical switches based on whether or not the test beam has been detected in the plurality of optical switches.

According to the remote control device, in the specific optical node, the plurality of optical switches may enter a new connection state when one of the plurality of optical switches is changed to another optical switch connectable to the same path as the plurality of optical switches, a test beam may be transmitted to one of the plurality of optical switches in the new connection state, and determination that one of the plurality of optical switches has an abnormality may be performed based on whether or not the test beam has been detected in the plurality of optical switches.

According to the remote control device, the plurality of optical switches may be caused to enter a new connection state repeatedly a predetermined number of times, and determination that there is an abnormality in the specific optical node may be performed in a case where the test beam has not been detected in any connection state.

The remote operation system of the present disclosure may further include a server that manages connection information between the optical nodes in the optical fiber network, connection information between the optical switches provided in the optical nodes, and whether each of the optical switches provided in the optical nodes is normal or abnormal. The remote control device may refer to the server to connect the plurality of optical switches provided in the specific optical node to each other and determine whether or not an abnormality occurs in any one of the plurality of optical switches.

Each of the plurality of optical nodes may include an optical cross-connect unit that performs connection switching of the optical fiber network by using optical switches, an optical monitoring function unit that detects some beams passing through the optical cross-connect unit, and a remote control unit that controls the optical cross-connect unit based on a control signal from the remote control device and transmits a detection result in the optical monitoring function unit to the remote control device. The remote control device may determine whether or not the test beam has been detected in the specific optical node by using the detection result from the remote control unit provided in the specific optical node.

Note that the disclosures described above can be combined in any possible manner.

### Advantageous Effects of Invention

According to the present disclosure, it is possible to detect an abnormality of an optical switch inside an optical node.

### BRIEF DESCRIPTION OF DRAWINGS

FIG. 1 is a system configuration example illustrating an example of a remote operation system.

FIG. 2 is a configuration example of an optical node.

FIG. 3 is a configuration example of optical cross-connect unit.

FIG. 4 is a flowchart illustrating an example of a method for detecting an abnormality executed by a remote control device.

FIG. 5 is an illustration diagram of the method for detecting an abnormality.

FIG. 6 is an illustration diagram of a method of isolating an abnormal position.

FIG. 7 is an illustration diagram of the method of isolating an abnormal portion.

### DESCRIPTION OF EMBODIMENTS

Hereinafter, embodiments of the present disclosure will be described in detail with reference to the drawings. The present disclosure is not limited to the embodiments to be described below. These embodiments are merely examples, and the present disclosure can be implemented in a form with various modifications and improvements based on the knowledge of those skilled in the art. Note that components having the same reference numerals in the present specification and the drawings denote the same components.

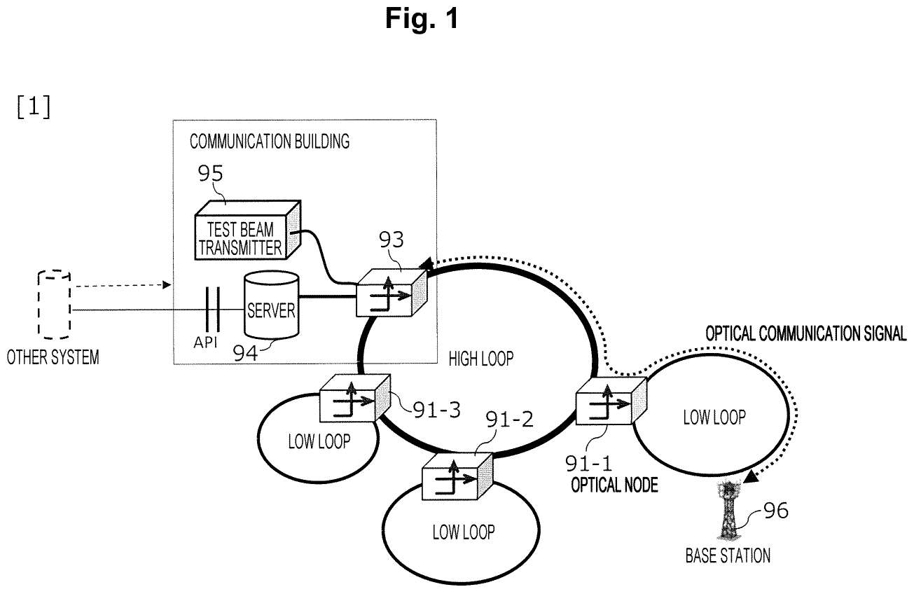

FIG. 1 illustrates a configuration example of a remote operation system that performs connection switching of an optical fiber by remote operation. The remote operation system of the present disclosure includes a remote control device 93 installed in an environment with a power supply, such as a communication building, and one or a plurality of optical nodes 91-1, 91-2, and 91-3 arranged remotely.

FIG. 1 illustrates an example in which an optical fiber network is an access network connecting an optical node installed in a communication building and a communication terminal on a user side, an optical access network has a multi-loop configuration including a plurality of loop shapes, and an optical communication signal is transmitted from the optical node installed in the communication building to a base station 96 on the user side. In the optical fiber network, the optical nodes 91 are installed at positions to which an adjacent loop is connected. The remote control device 93 also has a function as an optical node installed in an environment with a power supply. In addition, although the drawing illustrates an example in which there are only three optical nodes, the number of optical nodes may be any number of two or more. Hereinafter, the optical nodes 91-1, 91-2, and 91-3 will be referred to as optical nodes 91 when not distinguished from each other.

The remote control device 93 can simultaneously realize functions of performing optical power supply to the plurality of optical nodes 91 by using a single beam source and controlling a plurality of optical switches included in each optical node 91. In addition, mutual connection and switching are performed in units of optical fibers. The optical nodes 91 are installed in an optical fiber network and perform mutual connection and switching in units of optical fibers.

In the communication building, a server 94 is installed and manages mutual connection information of the optical fibers 92 between the plurality of optical nodes 91. In addition, the server 94 manages information of an optical cable in an optical fiber network, an optical fiber number between the plurality of optical nodes 91, or the like, which is provided in cooperation with another system. In addition, the server 94 manages connection information between internal optical switches used by the optical nodes 91. The connection information between the optical switches is, for example, a connection state between ports included in the optical switches. In addition, the server 94 manages a normal or abnormal state of all of the optical switches in each optical node 91 installed in the optical fiber network.

The remote control device 93 exchanges data in cooperation with the server 94 and controls the optical nodes 91 installed in the optical fiber network. For example, the remote control device 93 sets and connects a route of an optical fiber between the communication building and the base station 96 illustrated in FIG. 1. However, in a case where connection cannot be established, an alternative route can be set from an unused port of the optical nodes 91, and the connection can be established by the alternative route.

In addition, a test beam transmitter 95 that emits a test beam of a specific wavelength and can check the optical intensity at the time of transmission may be installed. In this case, the test beam transmitter 95 can insert the test beam into any optical fiber in which optical node switching is performed in the optical fiber network established through the communication building.

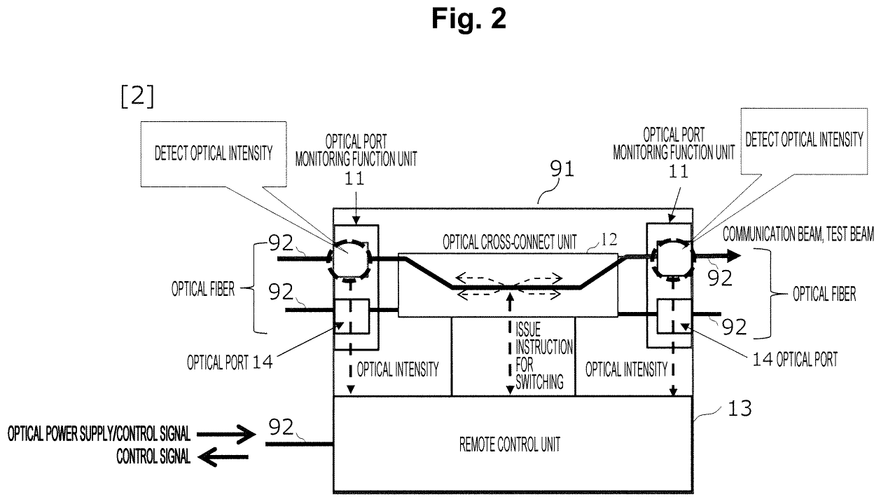

FIG. 2 illustrates an example of a functional configuration of the optical node. The optical node 91 includes an optical port monitoring function unit 11 that functions as an optical monitoring function unit that detects some of transmitted beams, an optical cross-connect unit 12 that switches connection of optical fibers, and a remote control unit 13 for controlling the units from the remote control device 93 installed in the communication building. The remote control unit 13 is a function unit that controls the optical cross-connect unit 12 on the basis of a control signal from the remote control device 93.

The remote control device 93 installed in the communication building switches the optical cross-connect unit 12 in response to an optical power supply/control signal. The communication beam and the test beam from the remote control device 93 sequentially pass through an optical port 14 and the optical port monitoring function unit 11 on an input side, the optical cross-connect unit 12, and the optical port monitoring function unit 11 and an optical port 14 on an output side. The two optical port monitoring function units 11 detect some of any beams passing through the optical port 14, such as communication beams and test beams and measure the optical intensity of the beams. The remote control unit 13 stores a value of the optical intensity of a detection result as data in a control signal and transmits the control signal to the remote control device 93. As the optical fiber for remote control, an additional optical fiber for control other than an optical fiber for communication in the optical fiber network may be used.

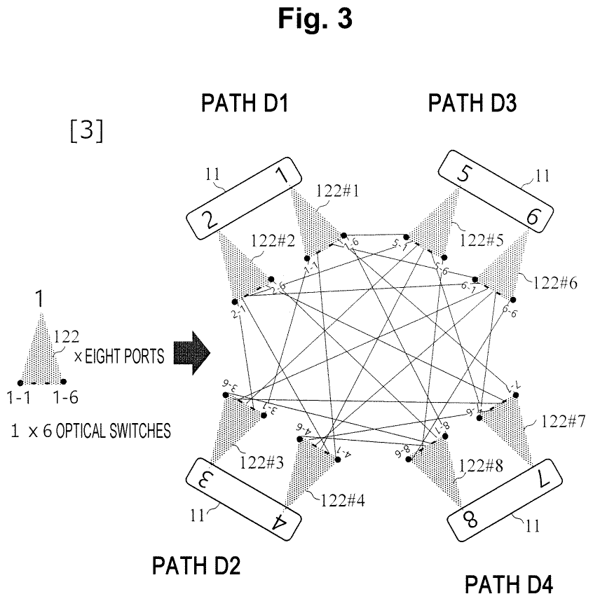

FIG. 3 illustrates a functional configuration example of the optical cross-connect unit. The optical cross-connect unit 12 can be configured by combining optical switches 122 having 1×n channels (n is an integer). FIG. 3 illustrates a configuration in which two 1×6 optical switches 122 are arranged for every four paths D1 to D4 provided in the optical node 91-1, and the four paths D1 to D4 are optically connected to each other by 2⁴ cross-connects between different paths. Consequently, it is possible to execute optical connection by an alternative route by switching channels on the output side of the 1×6 optical switches 122 at two positions.

A number described in each optical switch 122 indicates a port number. For example, six ports on the output side which have a port number #1 are indicated by 1-1 to 1-6. The same applies to six ports having each of the other port numbers #2 to #8. In the present disclosure, the port numbers #1 and #2 are connected to the path D1, the port numbers #3 and #4 are connected to the path D2, the port numbers #5 and #6 are connected to the path D3, and the port numbers #7 and #8 are connected to the path D4.

The optical node 91 includes a certain number or more of optical switches 122, and switching is performed by remote control from the remote control device 93. However, in a case where some kind of abnormality occurs, switching between the optical switches 122 may not be normally performed. However, regarding the abnormality generated in the optical switches 122, currently, there is no method and system for detecting an abnormal position from the remote control device 93.

Here, the optical node 91 has a structure that is driven by a minute power supply beam, but it is desirable not to newly include a sensor or the like for abnormality detection since there is a demand for driving with power saving. From the viewpoint of power saving, a method and a system for detecting an abnormality by using functions provided in the current optical nodes 91 are desirable. Further, the optical nodes 91 are assumed to be installed in a wide range of sites in the optical fiber network, and a site in which repairing cannot be immediately performed even though malfunction occurs, such as in a manhole in an underground section, is also assumed. Therefore, it is desirable to set an alternative route and enable an operation to be provisionally performed using the alternative route.

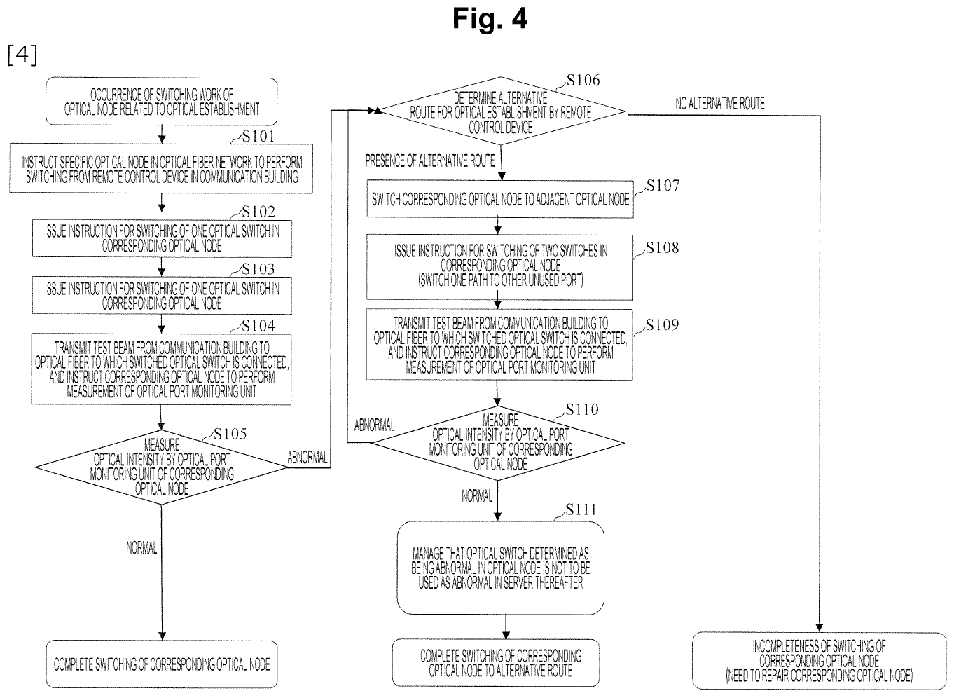

In a case of processing in which the remote control device 93 detects an abnormality of an optical switch, isolates the optical switch having the abnormality, and establishes an alternative route when the optical node switching work related to the optical establishment occurs, the remote operation system of the present disclosure performs the work based on the flow illustrated in FIG. 4. Consequently, the remote operation system of the present disclosure can not only detect an abnormality but also identify a malfunctioning position of the optical switch 122 by using the optical port monitoring function unit 11 which is a function already included in the optical node 91.

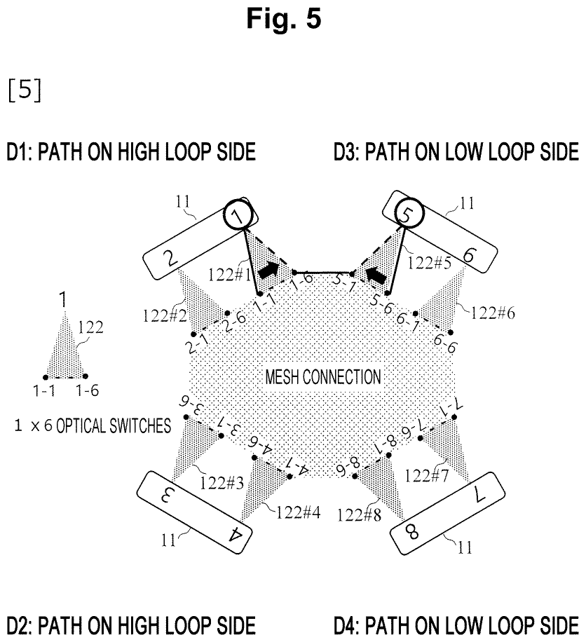

Specifically, when the optical node switching work related to the optical establishment occurs, the remote control device 93 executes the following steps S101 to S111. Abnormality detection is performed in steps S101 to S105, and abnormality isolation is performed in steps S106 to S110. Hereinafter, an example in which a specific optical node that is a detection target is the optical node 91-1 will be described with reference to FIGS. 5 to 7.

In step S101, the remote control device 93 instructs the specific optical node 91-1 in the optical fiber network to perform switching to connect the remote control device 93 functioning as an optical node in the communication building and the optical node 91-1. Consequently, the remote control device 93 and the optical node 91-1 are connected. In the present embodiment, an optical switch 122 #1 of the optical node 91-1 is connected to the remote control device 93.

In step S102, the remote control device 93 instructs the optical node 91-1 to switch one optical switch. For example, the remote control device 93 issues an instruction for switching of the connection of the optical switch 122 #1 of the port #1 of the optical node 91-1 to the port #1 and the port #1-6. Consequently, the port #1 and the port #1-6 are connected as illustrated in FIG. 5.

In step S103, the remote control device 93 instructs the optical node 91-1 to switch one optical switch. For example, the remote control device 93 issues an instruction for switching of the connection of an optical switch 122 #5 of the port #5 of the optical node 91-1 to the port #5 and the port #5-1. Consequently, as illustrated in FIG. 5, the port #5 and the port #5-1 are connected.

In step S104, the remote control device 93 transmits the test beam from the test beam transmitter 95 to an optical fiber to which the switched optical switch 122 #1 is connected. In addition, the remote control device 93 instructs the optical node 91-1 to measure the optical intensity by the optical port monitoring function unit 11.

In step S105, in the remote control device 93, the optical port monitoring function unit 11 of the optical node 91-1 measures the optical intensity. In the present embodiment, the optical port monitoring function unit 11 of the optical node 91-1 measures the optical intensity of the test beam at the port #1 and the port #5. The remote control device 93 acquires the optical intensity measured by the optical port monitoring function unit 11 through the remote control unit 13 of the corresponding optical node.

Here, in the present embodiment, the port #1-6 and the port #5-1 are connected. Therefore, the port #1 and the port #5 are connected through steps S102 and S103. In addition, the port #1 is positioned on a high loop side. Therefore, when the connection is normal, the test beam passes from the port #1 to the port #5, and the optical port monitoring function units 11 of the port #1 and the port #5 measure the optical intensity of the test beam. Therefore, the remote control device 93 can determine whether or not an abnormality occurs in the optical switches 122 #1 and 122 #5 on the basis of the measurement of the optical intensity by the optical port monitoring function units 11 of the port #1 and the port #5 (normal in S105), thereby confirming that the switching has been normally completed. In this case, the switching of the optical node 91-1 is completed.

In the case where the port #1 and the port #5 are not normally connected, the optical intensity of the test beam cannot be measured at the port #5. In this case, the remote control device 93 determines that an abnormality has occurred (abnormal in S105).

As described above, in the present disclosure, by connecting the ports in the optical node 91 (S102 and S103) and measuring the optical intensity in the optical port monitoring function unit 11 (S104 and S105), it is possible to determine an abnormality such as a failure in connection by the optical cross-connect unit 12 inside the optical node 91-1.

It is necessary to isolate the malfunction, and it is necessary to isolate the port #1 and the port #5. Therefore, in order to confirm the abnormal position, the check is performed by performing switching to another unused port of the alternative route connectable to the same path. Note that, in the following description, it is assumed that the same path of the port #2 or the port #6 is not used.

In step S106, the remote control device 93 in the communication building determines an alternative route for optical establishment. For example, the port #2 is connected to the path D1 of the port #1, and the port #6 is connected to the path D3 of the port #5. Therefore, the remote control device 93 determines the port #2 connected to the path D1 as an alternative route for optical establishment.

In step S107, the remote control device 93 switches the optical fiber connected to the port #1 of the optical node 91-1 to the port #2.

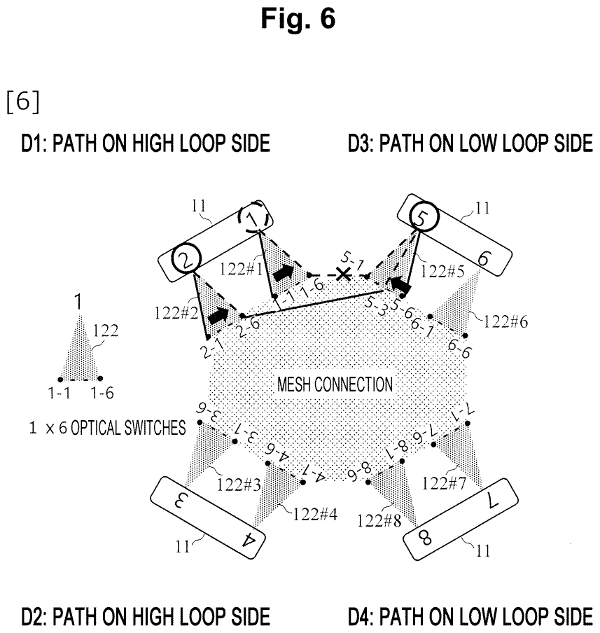

In step S108, a switching instruction is issued to the optical node of the corresponding optical node 91-1. For example, as illustrated in FIG. 6, the remote control device 93 switches the optical fiber to be used for connection with the upper side of the optical node 91-1 from the port #1 to the port #2. Then, the remote control device 93 issues an instruction to switch core lines of the two optical switches 122 #2 and 122 #5 such that one path is switched to another unused port, in the optical node 91-1. For example, the remote control device issues an instruction for switching of the connection of the optical switch 122 #2 of the port #2 of the optical node 91-1 to the port #2 and the port #2-6. In addition, the remote control device issues an instruction for switching of the connection of the optical switch 122 #5 of the port #5 of the optical node 91-1 to the port #5 and the port #5-3.

In step S109, the test beam is transmitted from the test beam transmitter 95 to the optical fiber to which the switched optical switch 122 #2 is connected. The optical node 91-1 is instructed to measure the optical intensity by the optical port monitoring function units 11.

In step S110, the optical port monitoring function units 11 of the optical node 91-1 measure the optical intensity. In the present embodiment, the optical port monitoring function units 11 of the optical node 91-1 measure the optical intensity of the test beam at the ports #2 and #5. The remote control device 93 obtains the optical intensity measured by the optical port monitoring function units 11 through the remote control unit 13 of the optical node 91-1.

Here, in the present embodiment, the port #2-6 and the port #5-3 are connected. Therefore, the port #2 and the port #5 are connected through steps S107 and S108. In addition, the port #2 is positioned on the high loop side. Therefore, if a measurement result is normal, the test beam passes from the port #2 to the port #5, and thus the optical port monitoring function units 11 of the port #2 and the port #5 measure the optical intensity of the test beam (normal in step S110). In this case, the remote control device 93 can confirm that the switching is normally completed based on the detection of the test beam by the optical port monitoring function units 11 of the port #2 and the port #5. In addition, from this result, malfunction of the optical switch 122 #1 of the port #1 is determined.

In step S111, the optical switch 122 #1 of the port #1 determined as being abnormal in the optical node 91-1 is managed not to be used as abnormal in the server 94 thereafter. Consequently, the switching of the optical node 91-1 is completed to the alternative route using the port #2 and the port #5. Note that the optical switch 122 #1 determined to have malfunctioned is to be repaired at a possible timing (taking action in planned maintenance).

On the other hand, in a case where the optical port monitoring function unit 11 of the port #5 cannot measure the optical intensity of the test beam, it is assumed that the optical switch 122 #5 of the port #5 may malfunction, the optical switches 122 #1 and 122 #2 of the port #1 and the port #2 may both malfunction, and all the optical switches 122 #1, 122 #2, and 122 #5 of the port #1, the port #2, and the port #5 may malfunction. Therefore, the remote control device 93 determines that an abnormality has occurred (abnormal in S110). In this case, steps S106 to S110 are repeated again. For example, subsequently, the following operations are performed.

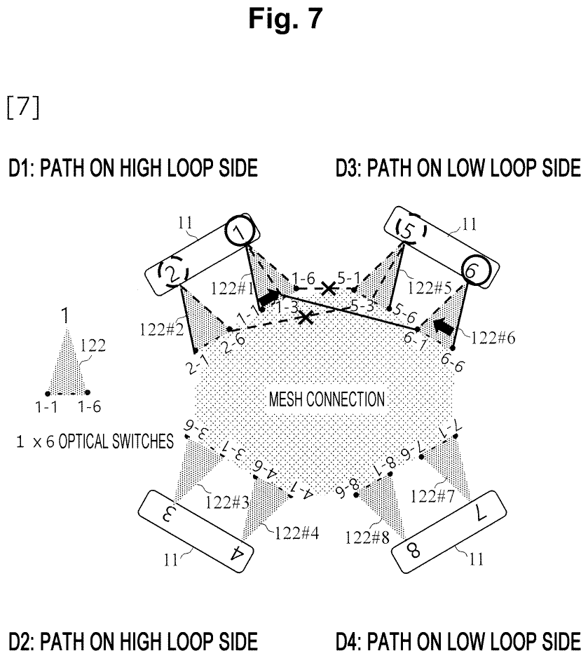

The remote control device 93 switches the optical fiber used in the corresponding optical node 91-1 from the port #2 to the port #1 (S108). Next, connection of the port #6 as an alternative route of the port #5 of the optical node 91-1 to the port #1 is attempted (S108). Specifically, as illustrated in FIG. 7, the remote control device 93 issues an instruction for switching of the connection of the optical switch 122 #1 of the port #1 of the optical node 91-1 to the port #1-3. Similarly, the remote control device issues an instruction for switching of the connection of the optical switch 122 #6 of the port #6 of the optical node 91-1 to the port #6-1. The port #1-3 and the port #6-1 are connected. Consequently, the port #1 and the port #6 are connected.

Next, the test beam is transmitted from the test beam transmitter 95 to the optical fiber in the optical fiber network to which the port #1 of the optical node 91-1 is connected from the communication building side (S109). Subsequently, the optical port monitoring function units 11 of the optical node 91-1 check the test beam transmitted to the port #1 and the port #6 (S110).

If a checking result is normal, the test beam passes from the port #1 to the port #6, so that the optical port monitoring function units 11 of the port #1 and the port #6 check the test beam. In this case, it can be confirmed that the switching is normally completed. In addition, from this result, malfunction of the optical switch 122 #5 of the port #5 is determined, and thereafter, it is assumed that the optical switch 122 #5 of the port #5 will not be used. Note that the corresponding optical switch 122 #5 is to be repaired at a possible timing (taking action in planned maintenance).

On the other hand, in a case where the test beam cannot be checked in the optical port monitoring function unit 11 of the port #6, the plurality of optical switches 122 malfunction as follows. That is, it is assumed that both the optical switches of the port #5 and the port #6 may malfunction, both the optical switches of the port #1 and the port #2 may malfunction, three optical switches 122 of the optical switches of the port #1, the port #2, the port #5, and the port #6 may malfunction, and all the optical switches 122 of the port #1, the port #2, the port #5, and the port #6 may malfunction. As described above, the present disclosure can determine which optical switch 122 may be abnormal of the optical switches 122 used in the optical node 91-1.

Thereafter, in order to confirm the abnormal optical switch 122, switching to unused ports on the same path one by one is performed, the optical port monitoring function units 11 measure the optical intensity, and the switching is continued until the no abnormality can be confirmed in the remote control device 93. However, if there is no unused port (no alternative route in step S106), switching cannot be performed. In this case, the remote control device 93 determines that switching of the corresponding optical node 91-1 is not completed and that the optical node 91-1 needs to be repaired.

It is preferable to operate the optical node 91 in a power-saving manner. Therefore, an upper limit may be set to the number of changes instead of continuing the change of the alternative route as long as there is an alternative route. As described above, in a case where switching is performed a certain number of times or more, and abnormalities are simultaneously confirmed in the plurality of optical switches 122, an operation of immediate malfunction repairing is performed on the optical switch 122 of the corresponding optical node 91-1 instead of the change in the alternative route. Consequently, an effect of suppressing power consumption by the optical node 91-1 is achieved.

As described above, the present disclosure using the remote control device 93 enables the occurrence of the abnormality to be detected from the communication building in real time in the case where an abnormality such as a failure in connection by the optical cross-connect unit 12 inside the optical node occurs. Further, the present disclosure can switch a malfunctioning port to an adjacent port by using the remote control device 93. Therefore, the present disclosure can cope with malfunction of an optical switch without sending an operator to a malfunctioning optical node to perform repairing work.

The remote control device 93 according to the present invention can also be implemented by a computer and a program, and the program can be recorded in a recording medium or provided through a network. A program of the present disclosure is a program for causing a computer to be implemented as each function unit included in the remote control device 93 according to the present disclosure and is a program for causing a computer to execute each step included in the method that is executed by the remote control device 93 according to the present disclosure.

### REFERENCE SIGNS LIST

11 Optical port monitoring function unit
12 Optical cross-connect unit
13 Remote control unit
14 Optical port
91, 91-1, 91-2, 91-3 Optical node
92 Optical fiber
93 Remote control device
94 Server
95 Test beam transmitter
96 Base station
122 Optical switch

1. A remote control device that is connected to an optical fiber network in which a plurality of optical nodes are connected to each other and performs connection switching of the optical fiber network by remote operation using optical switches provided in the optical nodes, wherein
in a specific optical node of the plurality of optical nodes, a plurality of optical switches provided in the specific optical node are connected to each other,
a test beam is transmitted to one of the plurality of optical switches, and
whether or not an abnormality occurs in the plurality of optical switches is determined based on whether or not the test beam has been detected in the plurality of optical switches.

2. The remote control device according to claim 1, wherein
in the specific optical node, the plurality of optical switches enter a new connection state when one of the plurality of optical switches is changed to another optical switch connectable to the same path as the plurality of optical switches,
a test beam is transmitted to one of the plurality of optical switches in the new connection state, and
determination that one of the plurality of optical switches has an abnormality is performed based on whether or not the test beam has been detected in the plurality of optical switches.

3. The remote control device according to claim 2, wherein
the plurality of optical switches are caused to enter a new connection state repeatedly a predetermined number of times, and
determination that there is an abnormality in the specific optical node is performed in a case where the test beam has not been detected in any connection state.

4. A remote operation system comprising:
the remote control device according to claim 1; and
a plurality of optical nodes which are connected in the optical fiber network and in which connection switching of a plurality of optical switches provided in the remote control device is performed using a power supply beam from the remote control device.

5. The remote operation system according to claim 4, further comprising:
a server that manages
connection information between the optical nodes in the optical fiber network,
connection information between the optical switches provided in the optical nodes, and
whether each of the optical switches provided in the optical nodes is normal or abnormal, wherein
the remote control device refers to the server to connect the plurality of optical switches provided in the specific optical node to each other and determine whether or not an abnormality occurs in any one of the plurality of optical switches.

6. The remote operation system according to claim 4, wherein
each of the plurality of optical nodes includes
an optical cross-connect unit that performs connection switching of the optical fiber network by using optical switches,
an optical monitoring function unit that detects some beams passing through the optical cross-connect unit, and
a remote control unit that controls the optical cross-connect unit based on a control signal from the remote control device and transmits a detection result in the optical monitoring function unit to the remote control device, and
the remote control device determines whether or not the test beam has been detected in the specific optical node by using the detection result from the remote control unit provided in the specific optical node.

7. A method for detecting an abnormality which is executed by a remote control device that is connected to an optical fiber network in which a plurality of optical nodes are connected to each other and that performs connection switching of the optical fiber network by remote operation using an optical switch provided in the optical node, the method comprising:
connecting a plurality of optical switches provided in a specific optical node to each other, in the specific optical node of the plurality of optical nodes;
transmitting a test beam to one of the plurality of optical switches; and
determining whether or not an abnormality occurs in the plurality of optical switches based on whether or not the test beam has been detected in the plurality of optical switches.

8. A program for causing a computer to function as the remote control device according to claim 1.
